(19) United States
(12) Patent Application Publication
(10) Pub. No.: US 2017/0069036 A1
(43) Pub. Date: Mar. 9, 2017

(54) System and method for timekeeping and billing to create and maintain employees and independent contractors

(71) Applicants: Ahmed Farouk Shaaban, South Barrington, IL (US); Venkat Thandra, South Barrington, IL (US)

(72) Inventors: Ahmed Farouk Shaaban, South Barrington, IL (US); Venkat Thandra, South Barrington, IL (US)

(21) Appl. No.: 14/756,686

(22) Filed: Jun. 29, 2015

Related U.S. Application Data
(60) Provisional application No. 61/998,577, filed on Jun. 30, 2014.

(51) Int. Cl. G06Q 40/00

(52) U.S. Cl. CPC G06Q 40/125

(57) ABSTRACT

The present invention consists of an improved system and method for entering and maintaining worker data for a company's employees and independent contractors wherein the system may link worker data directly to contracts and agreements between the worker and the employer, store an employee handbook for the employee, store large volumes of data and agreements relating to the worker's employment including all degrees and licenses, any special skills and language proficiencies. The system can import large amounts of worker data necessary for checking conflicts and for utilizing the worker's existing social media accounts for marketing purposes. The system will also allow the worker data to be translated and viewed in a plurality of languages. The system can also track a wide range of post employment data including pension, insurance, and death benefits paid to beneficiaries.

### PRIORITY CLAIM

The present application herewith claims priority of Provisional App. No. 61/998,577, which was filed Jun. 30, 2014, and shall be considered as if fully set forth herein.

### FIELD OF THE INVENTION

The present invention relates to the field of timekeeping and billing for professional companies and firms, as well as consulting companies, and more particularly, improved systems and methods to create, maintain, control and manage employees, workers, staff, independent contractors, professionals and non-professionals in a company environment.

### BACKGROUND OF THE INVENTION

In the current marketplace, there are a variety of computerized time and billing systems for professional firms. Some of these systems are computer-based while others operate in a cloud-computing environment. These systems, however, are not suited for large law firms with multiple offices in a plurality of countries, which must be linked together for proper billing and financial management. In addition, these are basic programs, which do not contain the most up to date features. Other numerous and varied disclosures related to billing and timekeeping are also disclosed in the prior art shown below.

EP 1,145,162 issued to Ashby discloses the use of a System for processing credit applications, financial and insurance services and administrative and management tools. The System generates a price quote for insurance and finance and facilitates on-line credit application processing. It also performs: inventory tracking, insurance tracking, purchase tracking, applicant profiling, targeted marketing, customer satisfaction, etc.

EP Patent No. 1,769,452 issued to Allin discloses the use of a computerized system for residential and commercial construction projects to maintain and disburse construction draws during construction. It can track lien waivers, distribute hundreds of checks to subcontractors each month, track construction change orders, and manage all persons involved in each draw. It manages and generates a construction budget and timeline. It also manages payments to material supplier, stores inspection data for each project, manages budgets for GC's as well as the subs and handles ACH payments.

EP Patent No. 2,026,222 issued to Alquier discloses the use of a system and method which allows the addition, modification and deletion of database fields without the use of a data base administrator. The system allows the addition and modification of an informational structure dynamically distributed directly via the user interface. It supports different types of entity attributes including, text, numerical information, date and time, predefined values and binary objects, allows the creation of relational dependencies between information entities (e.g., patent/child), provides flexible reporting capabilities including spreadsheets, slides, documents, timelines, etc.; it allows a configurable data entry interface; it allows importation of data from external sources; it allows full text searches; logs modifications for an audit trial; includes email notifications. It allows for a user interface that is flexible and configurable. However, it is not directed toward time tracking and billing generation.

U.S. Patent Disclosure No. 2003/0120538 filed by Boerke, et al. discloses the use of a method for tracking progress on a task by dividing the period of time into a plurality of timeslots and determining a target number of subtasks to be completed during each timeslot. The system only tracks the number of subtasks completed for each timeslot. The method also keeps track statistically of variances in subtasks completed between workers. The process may be used for planning purposes, which helps a supervisor correct negative variances in worker performance. The progress can be logged into a computer or worksheet or in paper format. Problems are also noted by the method for correction to improve performance by variance cards.

U.S. Patent Disclosure No. 2013/00090968 filed by Borza, discloses the use of an employee management and scheduling method which is directed to ensure that adequate personnel are present as required and that statutory requirements are met and costs are tracked and minimized. Scheduling software is used to manage multiple employees at multiple locations. From one screen, a manager may create, edit and delete shifts and also have access to other aspects of managing the organization staffings with information about positions, teams, skills, etc. being provided. The System can print shift assignment reports and employee reports. However, this disclosure is directed toward scheduling employees and not tracking their time or billing for their time.

U.S. Patent Disclosure No. 2012/0233044 filed by Burger, et al., discloses the use of a method and system for labor project management and costing which may run on a cell phone app to monitor employee activity, identify faulty activity and manage allocation of labor resources. The system can be used to monitor managers and administrators as well as employees. The system can be used to transmit payroll information. A flag may be generated if the worker travels outside the permissible areas allocated to his role. The system stores employee photos, job locations, routes, job codes, SIC codes, etc. may be entered into the back end by an administrator. The system also generates reports, and has a “Dashboard” or summary report simply shows who is on the job, what time they arrived and GPS confirmation of location.

U.S. Patent Disclosure No. 2014/0258057 filed by Chen discloses the use of a system and method for tracking the user's time of a mobile device for the purpose of billing clients. The system is provided with a digital timer, which is launched at the time of arrival and then stopped when the employee leaves. It tracks time sending texts and emails. Time is recorded as soon as the professional receives a voice mail, phone call, text or email. The user can also input notes with the system's time recording and entry. The app automatically looks up the user's contacts list whether the call, email or text coming in is from a client, and if so, it begins to track it for billing purposes. If it is not in the contacts registry, the user is alerted and can add the contact as a client to be billed.

U.S. Patent Disclosure No. 2013/0290154 filed by Cherry, et al. discloses the use of the system and method to manage employees at a plurality of jobsites by providing a database wherein a set of job site data is stored therein. Employee devices may collect a set of time punch data and photos to store in the system. Management apps are used on supervisory devices to monitor the jobsite data and employees and validate photos and activate employee apps. This system is shown operating on a cloud environment. The system operates as a time tracking system for job sites. The system stores timed photos of the employees at check-in and check-out. The system also records a job number, a job phase and a cost code and also has a payroll calculator communicating with a payroll service.

U.S. Patent Disclosure No. 2001/0042032 filed by Chrawshaw discloses the use of a system for capturing, processing and reporting time and expense data which can include flat fee billing, maximum fee billing and will also allow for discounts and write offs. A client will not have access internal data of the company. The system will produce bills, expense reports, time sheets, proposals and project tracking. This appears to be a conventional program for law firm data, which is run on a local server for one location. The system may produce various reports as needed. Bills may be delivered by email. The program will create envelopes for the bills and will also create budgets for the client.

U.S. Pat. No. 6,038,547 issued to Casto discloses the use of a construction tracking and payment system for use by contractors and subcontractors so that work may be tracked and payment may be timely made after the work is completed and inspections performed. The system may be implemented on a handheld computer. The system will break down a construction job into various elements, and then a contractor or subcontractor will be given a copy of how the site is partitioned, then each contractor or sub is responsible for submitting applications using the partitioning to ensure uniformity the architect desires to impose. The system can import and use CAD information on the job site.

U.S. Pat. No. 6,747,679 issued to Finch, II, et al. discloses the use of a time keeping and expense tracking server including a server that implements computer instructions that define logic for building GUI screens according to user instructions. The user can implement and design the screens needed for the tasks of time keeping and expense tracking. The system may be implemented on the cloud or internet with a laptop or wireless device desired. The GUI screen may be customized on a company by company basis, a department by department basis, etc. The system also includes security wherein projects and project codes are only viewable by certain level employees.

U.S. Pat. No. 7,343,316 issued to Goto, et al. discloses the use of a network-based shift scheduling system for generating temporary shift workers. It is sent over portable terminals over a network. The system is set to secure and provide work for a plurality of workers. Workers can also submit cancellations or shift changes via the system. The system also accommodates email for communication purposes. The system may also recruit new employees. The system stores the name, age, sex address, mail address and qualifications of the employee, the workable time slots, the type of job, hourly wage, etc.

WPO 2014/016796 filed by Gupta, et al. discloses the use of a system and method for employee tracking in a mobile communication device wherein dynamic location reports may be generated in real time or near real time. The system is directed to door-to-door delivery or pickup sales forces. The System uses a mobile app on the employees cellphone to conduct the tracking of the employee. The system will raise flags if deviations from tracking occur. The system uses Blue Dophil software to analyze where employees should be performing tasks and produces flags when parameters gathered fall outside permissible ranges. These flags are sent to management via text or email.

U.S. Pat. No. 6,832,176 issued to Hartigan, et al. discloses the use of a method and system for tracking and reporting time spent on tasks in different application on the end users' computers while the tasks are being performed. It may track the opening and closing of files automatically and send reports and messages directly to and from other applications. The software may also suggest categories for each task based upon at least one criteria. It is directed toward attorneys and accountants. The system may track fixed fees and use data collected for evaluating production or sweat equity bonuses to employees. The system may track a plurality of projects or research endeavors, the time spent by accountants on spreadsheets, the time engineers spend on designing computer code or simulating circuit designs, time spent in applications such as MS Word, Excel, Outlook, Power Point, when the application is open, active and then closed. It can score and rate the usage of these various types of software automatically. Various reports may be generated by the system for management usage on a periodic basis, as desired.

WPO Patent Disclosure No. 2015/079776 to Hishiki discloses the use of a work state management system that manages clock in times for drivers of vehicles that work overnight shifts and calculates the appropriate breaks for the driver so that the driver is not overtired.

U.S. Patent Disclosure No. 2014/0344,122 filed by Hodgin, discloses the use for billing time spent in an IM session by a service person wherein the system can automatically bill a project/client by searching for the name of the client or project within a text or instant message or a series or session of same. If the system cannot find the name of a client or project, then the user will associate the IM session with a new project or client so that the client may be billed for the IM session with the client. The system may default into a common template for the user's typical instant messaging sessions.

U.S. Patent Disclosure No. 2009/0006228 filed by Hodgin discloses the use of a time tracking system and method similar to the IM system noted above by Hodgin. The Hodgin system will also store a list of prior associations to projects and clients that are built on the same or similar words and phrases.

U.S. Patent Disclosure No. 2002/0154122 filed by Jackson, Jr. discloses the use of an improved system for employers, referral agencies, consultants and independent contractors to hire and manage employees and provide tax reports and wage reports. The Jackson, Jr. system may track and manage employees, salaries and experience to provide optimal benefits to the employer. The System produces computerized scheduling, billing, record keeping and payment templates. It provides a listing of invoices for the user to refer to. It consists of providing invoices for contractor services and performs its functions in a cloud-based system.

U.S. Pat. No. 8,838,486 issued to Kong, et al., discloses the use of a time manager interface on a communications display device which allows a worker to keep track of her or his time and activities. The time manager keeps track of time spent logging into and out of the system. This was important in years past when boot time was quite long. It discloses the use of scanning in employee badges to track work time. In one version of an embodiment, the system is located in the field. It discloses the use of GPS in the field to create an audit trail of time worked. Biometric information may be used for the system to identify the worker.

U.S. Patent Disclosure No. 2012/0278211 filed by Loveland discloses a system for remotely tracking and monitoring Worker's activities via mobile phones or other mobile tracking devices. This system monitors continuously whether or not a worker is present at a worksite.

WPO 2010/11652 filed by Manser discloses a System and Method for tracking employee performance. The Manser system provides a user interface to allow the user to assess the balance of hard skills and soft skills of an employee, evaluate the employee's performance in a plurality of categories, and compare the average cost for the job in the marketplace to the cost of the employee being evaluated. The system also analyzes the average cost of a similar job in the relevant marketplace during employee reviews. The program continually monitors the value of an employee to the employer to determine ROI at any given time. The system can be applied to direct hires, contractors, temps or any employee relationship. The system allows the identification of both over achievers and under achievers. The system provides a means by which employees may determine how to get the highest ratings via their work efforts.

EP 2338293 filed by Molotsi discloses a system for time tracking for employers on a mobile computing device. The system involves providing an event manager on a mobile computing device for managing a plurality of events, which are then synchronized to a server. The system will automatically track time and estimate time spent on a task by the worker. This system logs events in the user's calendar, in emails and texts. Timestamps for events and mapping for the events are provided. A client list and data may be provided in one or more files or databases. The system may communicate with a worker's smartphone. The user may be able to open, edit, delete, review or manage all automatically created event records. The system may use information in the text, email, calendar, to automatically create a time tracking record for the user. In addition, the system may automatically convert emails, texts, and meetings on a calendar to a time tracking event by means of a pop up box to the user.

WPO 2008/061146 filed by Neveu Holdings, LLC discloses a system and method for remote time collection for employee time on job sites. The system can collect an employee's name, picture, title, contact information, health and/or safety information, skill information, etc. The system can also collect for each employee a project name, project identification, location, project start date, project supervisor and detailed comments about project activity. The system can also collect information on vendors, such as name, address, phone, contacts and type of vendor. The system can also use GPS information and compare it with when the employee is supposed to work. The system collects biometric information to identify an employee. In one embodiment, a time collection database is configured to receive, process and store information related to projects such as name, identification, location start date, supervisor, etc; vendor's name, address, number contact, subcontractor type, etc. project supervisors, tasks, employee titles, departments and employee time records. Office data collection may include: job site, task and project information via a wireless connection. Encryption is used to transmit data to and from the remote site. The system may also include a field scheduling module to schedule a job for a particular jobsite and for a specific remote user(s). The user can edit hours and view comments from remote workers. Remote monitoring can record task completion, view management comments and ask for management assistance and crew responsibilities.

U.S. Patent Disclosure No. 2015/0081381 filed by Okoba discloses a system and method for recording time which may be used on a device, software or application. It may be used by logging into a plugin or extension. The time recorded may be exchanged for vouchers which may be redeemed or traded with other members. A user will register with an ID and password to log into the system. The system may record device activity, software activity application activity, keyboard activity and mouse activity. The user's time spent in the browser or on a video game may be given a redeemable value. A database may store the recorded activity for further analysis.

U.S. Patent Disclosure No. 2015/0081487 filed by Porter, et al., discloses the use of a time tracking and productivity system including a tracking component to locate an employee to record time spent at various locations. This system is designed to monitor and improve coordination of patient care, and in particular, to limit the number of patient hours a resident physician can work per week. When the rules implemented by the ACGME are violated, strict fines and probations or suspension may be implemented.

This system is primarily concerned with tracking an employee's location and work hours. This system can include cloud performance. It is the movement of an employee within predetermined boundaries that will trigger the recording of a new event. It can track time in a patient's room, a brake area, doing paperwork, etc. A GUI is used on handheld devices. The system can also use tags that interact with RF signals. The system records employee info and FRIDA numbers, the resident program director, the resident coordinator, start and end times for resident shifts, house calls, hospital room calls, night float, etc. If moonlighting is permitted, the system can track moonlighting hours as well. It will store vacation schedules and rotation schedules. The shift log can include a short trip buffer. Automatic warnings of over limit hours are sent to management for the residents via text, phone, email, etc.

U.S. Pat. No. 6,185,514 issued to Skinner discloses a method and system for automatically collecting and analyzing information regarding time and work performed on a computer. It uses a data collector for monitoring certain portions of a worker's computer activity and an analyzer for showing which portions of the activity were continuous work activities, and the system will categorize the work into preset projects and tasks within a project. The information is periodically written to data storage. The system is directed toward telecommuters. The system automatically excludes time where there was no activity on a computer. The system is used to forecast future projects with reduced financial risk. The system includes the automatic documentation of time. The data stored on the system is encrypted so that it cannot be altered by the user. The data collector automatically collects the activity on a mouse and on the keyboard of the computer user. The system creates a log file of work activity. A hardware abstraction layer can interface with phones and other devices and can be used with pointing devices such as a tabled or mouse. The system keeps track of activities within open multiple windows on a computer.

U.S. Pat. No. 8,209,243 issued to Smith, et al., discloses the use of a system for performing real time labor management and timesheet reporting which is adapted to wirelessly transmit timesheet information. The portable devices may be dedicated to tracking time only and cannot perform other computing functions. The system includes a portable electronic punch system that is capable of communicating with the labor management system via text. The system allows user to manage work schedules and report timesheet information without requiring an internet accessible computer. The units send timesheet information directly back to the server for analysis via wireless network. The text messages may contain: employee ID, clock in time, clock out time, break times, days worked, days off and other work related information.

U.S. Pat. No. 9,020,848 issued to Ridge, et al., discloses the use of a method for tracking time and location of an employee according to a predefined schedule and it may utilize software to track the presence or non presence of: a NFC (near field communication), BLE (Bluetooth Low Energy) or other wireless device. The system will track the presence of an employee in a geo-fenced area. It will also track employee time and other data to log that into a payroll system. The low energy device then communicates data to a server if a signal could or could not be detected. It will also allow for manual clocking in and out in case of failure of the back end server. The system can also be used for security purposes. The system can function in real time or in batch request mode. It can be used to advise management when non-authorized employees enter a restricted work zone. Management may input which work zones are restricted and which are not.

WPO Disclosure 2015/029073 filed by Shirish discloses a system and method to measure aggregate and analyze time, effort and productivity by reviewing time spent on activities such as calls, travel, lab work, meetings, discussions and remote visits. Presence Devices (PD's) may be used to track employee location. The system can track average daily work patterns. It is intended to track effort and performance 24/7. It can provide modules that promote work focus and minimize distraction by awarding performance points, badges for consistent performance and progress in performance goals. It can measure improvement by creating an n-dimensional effort data cube and include analytics for custom reports. The system can go into self improvement mode to set goals for self improvement and activities related thereto. It has a time tracker for all online time. It has a merger to merge offline and online time effort mapping. It has an interference engine to determine Work Patterns for employees, leave taken, work done on holidays, desk or supervisory or travel oriented job, etc.

U.S. Pat. No. 2012/0173297 disclosed by Styn, et al., a method and system for task tracking and allocation is disclosed. The disclosure provides for a method in which an individual may create a set of instructions operable to perform a set of tasks in a computer readable medium. That set of tasks may comprise maintaining a database, generating a first interface displaying subjects associated with individual issues, and a second interface with notes specific to an issue selected by a user. However, Van Styn is not a true timekeeping and professional billing system.

US Pat. No. 2014/0108644 disclosed by Zaents, et al., a method and system for tracking time in a web-based environment is disclosed. The method of tracking time involves a web-based application to track time associated with several records. Identifying a record in an active state, generating a record associated with the active record and activating a timer, and having the ability to end the session in response to an indication that the record is an inactive state. The method may detect a predetermined total duration of time has been exceeded and provide such indication to user.

However, none of the above patent disclosures teach or suggest improved billing and timekeeping systems which are able to create, maintain and edit personnel data and other hum an resources information in real time and via an online account with an employees. These and other additional objects and advantages are readily derived from the disclosures and drawings provided herein.

### SUMMARY OF THE INVENTION

The present invention consists of a System and method to create, maintain, edit and manage employees and independent contractors. The process begins by entering fields such as name, address, date of birth, office, practice group, areas licensed, dates of licensing, websites, emails, etc. When a resume comes into Human Resources in response to a job posting or ad, it is assigned to the Practice Group handling that type of employee or staff.

After the information is approved by management, the employee or independent contractor ID is published to those that practice in the relevant practice area. During the interview process, the resume and name is circulated to those involved in the hiring process for that practice area. Comments are collected on the resume, which is then released back to Human Resources and, if the resume makes a certain number of approvals, the candidate is requested to come in for an interview before the partners or management staff as appropriate.

When collecting data for a candidate, the System provides a drop down box of universities, cities, and colleges to categorize the new candidate. Users may add new universities and colleges and the types of degrees awarded, if any. The System can capture more than 150 pieces of data for each Personnel Number.

The System can create user-defined fields. Ability to distinguish different types of employees or contractors (for examples, attorneys for Italy) who are subject to different classifications or tax structures. (For example, following the distinctions and rules in Italy, which call for 2 types of attorneys—consultants who are subject to SST tax and those who are not subject to SST tax,) the system allows for the process to tag such distinctions for records and billing or any other purpose. (Another example, following distinctions made in Hong Kong, the process allows for the ability to tag a Timekeeper (Employee, Contractor) as a Chinese bar registered or other professional licensing. For example, any attorney in Hong Kong who is not bar registered in Hong Kong uses the title “Foreign Legal Consultant” in the “published rank” field while still using standard title codes. This effects treatment of taxes and billing. Differentiation is necessary as Non-Society Timekeeper's salaries are expensed whereas Society Timekeeper's salaries are recognized as profit-distribution on Firm's books. These types of differentiations can be noted for all countries and all professions.

During the interview process, the System will rate the proficiency of the languages spoken and written by the candidate, as well as record translation certifications. The System will have the ability to import and export candidate data to and from other software and systems in Excel, .csv, and other formats. The System will store past jobs, titles, salaries, licensing, and any other relevant information. Upon hiring, the new candidate will be designated as a Timekeeper and the System will also determine whether the Timekeeper is subject to sales tax or VAT in the relevant jurisdiction. The Timekeeper will also be given a staff level, (e.g., Partner, Senior Partner, Junior Partner, Equity Partner, Non Equity Partner, Associate, Senior Associate, Legal Assistant, Paralegal). The Timekeeper will be assigned to multiple offices where he or she is able to practice. The System will record and keep track of job titles, licenses and any license renewals. The System will also remind the Employee to renew their license in advance of the expiration of said license. When Professional Management or Staff Management open a job position, a temporary account will be created for the job posting. Resumes for the job posting will be circulated to a preselected group of managers (Hiring Management Group) that will interview candidates for that job position.

The candidate will then go through a series of interviews with the Hiring Management Group. The candidate will then receive ratings and comments. Once Human Resources processes those comments, a decision will be made as to who will be hired. After the candidate has been offered the position, with all details of the salary, benefits and conditions of employment, she or he will have a Timekeeper number generated. A mass email will announce the new hire, as well as the Timekeeper's skills and abilities to all other employees at the firm. The necessary data is transferred into Human Resources' system for payroll.

The System is able to generate any of the following reports: FTE based reporting (headcount and productivity); 2) Terminations; 3) New Hire Term; 4) Loe Transfer; 5) Attorney Headcount; 6) Associates; 7) Associates by Date Employed; 8) Associates by Office; 9) Attorney Numbers; 10) Counsel Status; 11) Former Partners; 12) Former Partners by Effective Date; 13) Geographic Distribution of Partners; 14) Geographic Distribution of Principals—Local Partners and Associates; 15) Geographic Distribution of Employees within the Firm; 16) Lateral Partners; 17) Lateral Partners by Office; 18) Local Partners; 19) Local Partners by Office; 20) Number of Attorneys by Office; 21) Number of Principals by Office; 22) Principal Statistics; 23) Principals; 24) Principals by Date Became Partner; 25) Principals by Office; 26) 25 Years of Partnership; 27) Associate Insurance; 28) Partner Insurance; 29) Principals by Age; 30) Timekeeper FTE; 31) Primary Membership By Group; 31) Membership By Group; 32) Membership By AOL; 33) Membership By RPG; 34) Individual Membership Report; 35) Benefits Report; 36) Reporting based on effective change date (LPG/GPG level-for ad hoc reporting); 37) Years of experience “as of” date.

The System is able to distinguish different types of employees or contractors (for examples, attorneys for Italy) who are subject to different classifications or tax structures. (For example, following the distinctions and rules in Italy, which call for 2 types of attorneys—consultants who are subject to SST tax and those who are not subject to SST tax,) the system allows for the process to tag such distinctions for records and billing or any other purpose. (Another example, following distinctions made in Hong Kong, the process allows for the ability to tag a Timekeeper (Employee, Contractor) as a Chinese bar registered or other professional licensing. For example, any attorney in Hong Kong who is not bar registered in Hong Kong uses the title “Foreign Legal Consultant” in the “published rank” field while still using standard title codes. This effects treatment of taxes and billing. Differentiation is necessary as Non-Society Timekeeper's salaries are expensed whereas Society Timekeeper's salaries are recognized as profit-distribution on Firm's books. These types of differentiations can be noted for all countries and all professions.

The System is able to track Timekeeper (for example, Employee, Contractor) against various organizational assignments, including, but not limited to Local Practice Group (LPG), Global Practice Group (GPG), Regional Practice Group (RPG) and subgroups. These are all date effective. History must be kept for all the changes of Organizational Assignment.

The System may also be provided with security where only employees are able to view Human Resources Data by 1) name; 2) job title; 3) job level or 4) work department. The System will be able to hold English and non-English characters in it. In addition, the System will be able to track changes in Title, Jobs Held, Years of Experience and other important data that often changes.

The System is able to move a Timekeeper (employee/contractor) from one country to another. All attributes of the original Personnel Number must move to the new Personnel Number created manually or by use of various electronic systems such as, ERP for the new country with effective date. The former record must have an end date. The System is also able to change a Timekeeper (Employee, Contractor) from one Sub Practice Group to another Sub Practice Group with effective dates.

The present inventive System syncs to the billing and timekeeping system, in which time will not be entered for any dates prior to the hire date of an employee or after the termination date. FTE (Full Time Equivalent Reports) may be generated for headcount contractual matters and other employee data reports.

The System also syncs documents (i.e. resumes, references, letters of reference, employment agreement) according to Timekeeper ID. The employee is given an online account with a user ID and password and can review these documents as they are linked to his or her account under menu item “Employment Agreements and Documents.”

The System keeps track of pension benefits, 401(k) benefits, as well as other employee benefits. It also keeps track of benefits for employees that have left the company, as well as their job titles, length of employment, and other employment details. In the case that an employee passes away, the System will assess death benefits, survivor benefits, and other pension benefits, as well as who the beneficiaries are.

The present invention keeps track of the employee's contact information, as well as any social media that the employee may be using in association with his or her job. From said social media, the employee can send out announcements, articles, professional news and other information pertinent to the employee's job or the industry. Additional features of the present inventive system will include the ability to transfer an employee's information easily between local and regional offices and even undertake an inter-country move for any employee.

It should be observed that there are numerous configurations, options, additions and rearrangements of elements found in the prior art which are considered obvious to try and which should be considered as part of the summary of the present invention as if fully set forth herein.

### OBJECTS OF THE INVENTION

Thus, it is one primary object of the present invention to provide a System which has the capability to create, track, maintain, and store employee data (including: name, address, date of birth, dependents, salary, phone numbers, fax numbers, social media information) through a CPU and data storage unit. A further object of the present invention is the ability to link a plurality of employee information to other employees for the purpose of distributing professional news articles, announcements, and ads for new clients.

Another object of the present invention is to provide a system which has the capability to link employment documents, which include, but are not limited to: an employee handbook, employee agreement, state licensing information, renewals of licenses, and confidentiality agreements (non-attorneys), to an employee online account.

It is another object of the present invention to provide a listing of the employee's degrees, years of graduation, and other pertinent information. As the employee attains a new degree or certification, this will be entered into the System and an announcement will be made on the company's website, as well as the social media designated by the employee.

A further object is to provide a System which tracks and maintains employee data by tracking the employee throughout the duration of employment beginning from the time a resume is first submitted.

It is an additional object of the present invention to provide a System with a translator for all fields in the human resources database for review by authorized employees and managers.

Still a further object of the present invention is to record information after the employee has left the firm or company, including but not limited to: the termination date, pension benefits, life insurance terms, date of death, and all other related information.

Still a further object of the present invention is to provide a System that syncs the names of the new hire and his or her clients to the System for automatic loading into the billing and timekeeping software for spell check such that when the new-hire enters timekeeping records, the spell check will auto correct any errors.

Yet an additional object of the present invention is to provide a System which has the capability to create, track and maintain employee recording by providing a system which is accessible to named beneficiaries upon death, in which the system is able to transfer all death benefits afforded to the beneficiaries and next of kin of the deceased employee.

And still a further object of the present invention is to provide a System, which has the capability to create, track and maintain employee recording by automatically emailing or faxing to the employee, all hiring documents, including an approved employee agreement and employee handbook together with an offer of employment once the employee is approved for hiring.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a flow chart of the present invention.

FIG. 2 is a screen snapshot of the present invention, the improved system to create and maintain employees

FIG. 3 is a screen snapshot of the present invention, the improved system to create and maintain employees.

FIG. 4 is a screen snapshot of the present invention, the improved system to create and maintain employees.

FIG. 5 is a screen snapshot of the present invention, the improved system to create and maintain employees.

FIG. 6 is a screen snapshot of the present invention, the improved system to create and maintain employees.

FIG. 7 is a screen snapshot of the present invention, the improved system to create and maintain employees.

FIG. 8 is a screen snapshot of the present invention, the improved system to create and maintain employees.

FIG. 9 is a screen snapshot of the present invention, the improved system to create and maintain employees.

FIG. 10 is a screen snapshot of the present invention, the improved system to create and maintain employees.

FIG. 11 is a screen snapshot of the present invention, the improved system to create and maintain employees.

FIG. 12 is a screen snapshot of the present invention, the improved system to create and maintain employees.

FIG. 13 is a screen snapshot of the present invention, the improved system to create and maintain employees.

FIG. 14 is a screen snapshot of the present invention, the improved system to create and maintain employees.

FIG. 15 is a screen snapshot of the present invention, the improved system to create and maintain employees.

FIG. 16 is a screen snapshot of the present invention, the improved system to create and maintain employees.

FIG. 17 is a screen snapshot of the present invention, the improved system to create and maintain employees.

FIG. 18 is a screen snapshot of the present invention, the improved system to create and maintain employees.

### DETAILED DESCRIPTION OF THE DRAWINGS

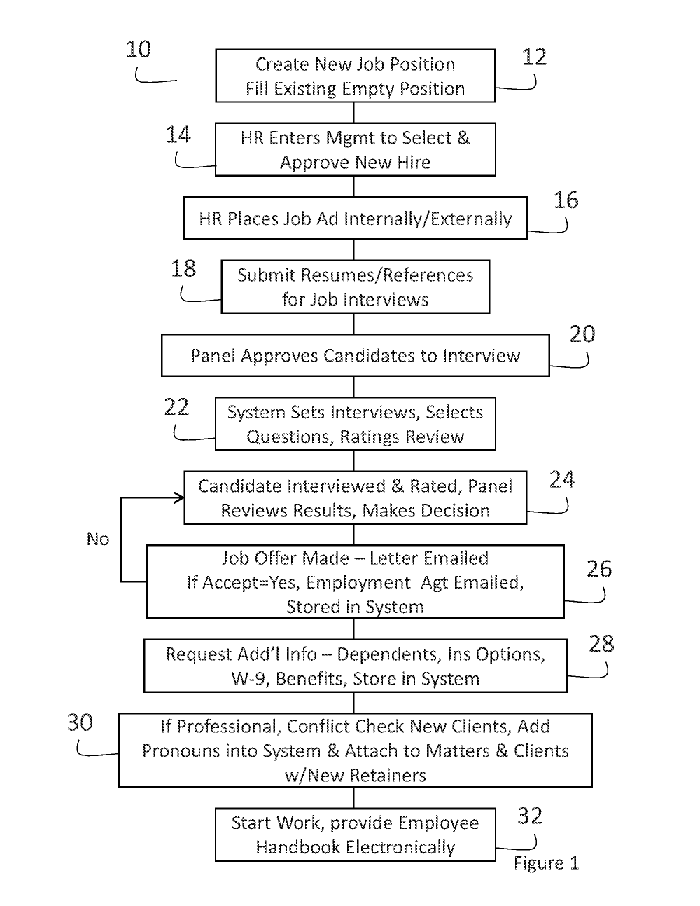

Shown now in FIG. 1 is a flow chart of the present invention System 10. FIG. 1 demonstrates the process, which begins with Human Resources noting that there is an Open Job Position 12. The next step is for Human Resources to create a Management Panel to hire the new employee. This data will be entered into the System for the approvals necessary 14 to hire a new person for the Open Job Position 12. Once the Panel has been selected, Human Resources will place ads 16 that are directed to attract qualified candidates for the job. Candidates will submit their resumes and references 18 directly to Human Resources, which will save qualified resumes in the System 10. The Management Panel will then select candidates to interview 20 based according to the rating of resumes and references. The System will email all candidates with possible times and dates to interview 22. The slots are filled up with an automated email process that is based on the availability of the Management Panel members, which is determined by their calendars. Before the candidates interview, the System emails the Management Panel with suggested interview questions, a review of the candidate's rating, and a copy of their resume 24. Once all the candidates have signed up for an interview, attended the interview, or sent notice that they no longer want to be considered, the ratings of the candidates will be tallied and sent to the Management Panel 24 to select one candidate for the job. After the job offer is made and accepted, the System will generate an employment agreement, including a proposed start date and a description of employee benefits. Once the new employee returns the signed employment agreement 26, it will be stored in the system, and if the new employee is assigned as a timekeeper, a timekeeper number and ID will be generated by the System. The System transfers detailed information from the resume (name, address, website phone, past employment history, education, colleges attended, licenses and dates of graduation and licensing) into the System to be stored in a database associated with the job position and employee. Employee documents such as the employment agreement, a current employee handbook, client agreements, etc. will be associated with a Timekeeper number and ID and will be accessible through the Timekeeper ID.

After the Timekeeper is officially hired, he or she can import their client's information into the System 30 via an Excel spreadsheet listing the name of client, address, phone number, website address, social media that the Timekeeper may want to review periodically. For a law firm, new clients must go through a conflicts check 30 to ensure lawyers at the firm have not already sued or taken an adverse position against any new lawyer joining the firm. Lawyers already at the firm should have a list of clients they represent now and in the past. New lawyers joining the firm should prepare a list of clients to bring to the firm, and a list of any adversaries in litigation or legal threats of suit. If there is a client match, the lawyers involved will need to decide how to work out any conflicts.

Further, when a new lawyer is hired, he or she must provide a form to all the lawyer's clients authorizing the transfer of files to the new firm. Once the new lawyer's client data has been uploaded into the System, this can be accomplished automatically with the proper forms. Further, if a new retainer agreement is required during the transfer, it may be issued by the System directly and then collected and stored automatically in the System.

The new Timekeeper will also provide the System with additional information such as W-9, dependent information, information to the company's insurers and requests for benefits 28. Finally, the new Timekeeper will start work on the date designated between the parties, and the Timekeeper will receive a copy of the employee handbook 32.

Once the client information has been stored in the System, the Timekeeper can use the social media information to distribute firm announcements, letters and articles of interest, and other marketing materials and information related to the practice of the type of law the client has used the Timekeeper for. This social media information can also be used for any type of employee, whether it is a consultant or independent contractor that needs to develop and maintain a client database for enhanced profitability to a company or firm.

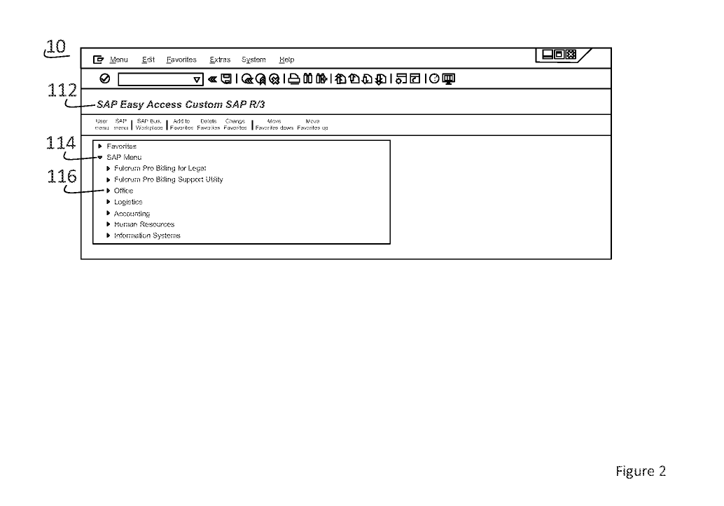

FIG. 2 shows the present inventive System 10 (which may also be used for independent contractors providing regular services to a firm or company) including: Header 112 titled “SAP Easy Access Custom SAP”, SAP menu directory 114 and an Office Subdirectory 116 for storing employee data.

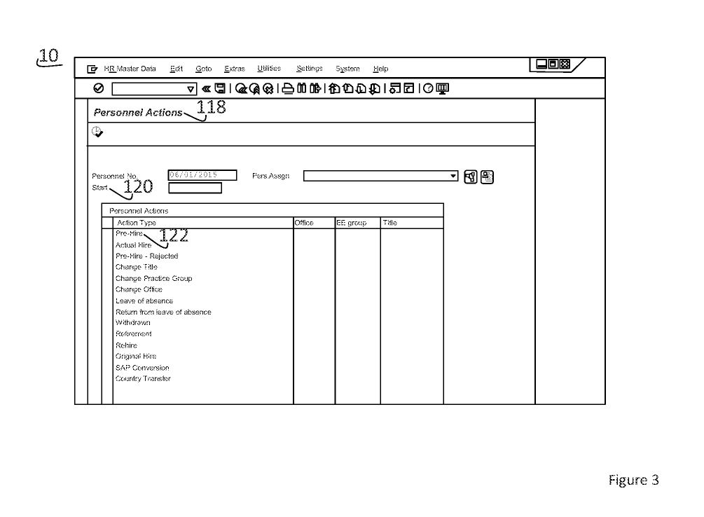

FIG. 3 shows the present inventive System 10 having a Header 118 “personnel Actions” and a Start Date 120, and the action to be taken is to select the “pre-Hire” 122 menu selection for a new-candidate for an open job position.

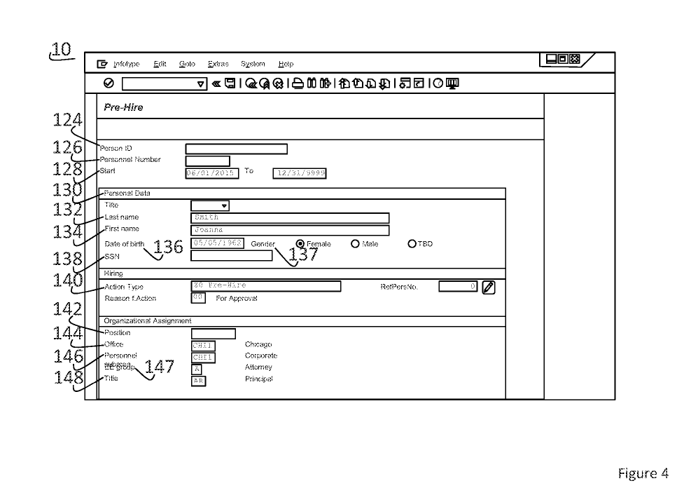

FIG. 4 shows the present inventive System 10 with a Person ID 124, a Personnel Number 126, a Start Date 128 for the pre-hire, a section with a Header 130 “Personal Data” and last name field 132, First name field 134, Date of Birth 136,

Gender 137, Social Security Number 138, Action Type 140 of “Pre-Hire”, Position 142, which the candidate is applying for, Office code or ID 144, Personnel subarea 146, Employee Group 147 and Title 148 to be applied for.

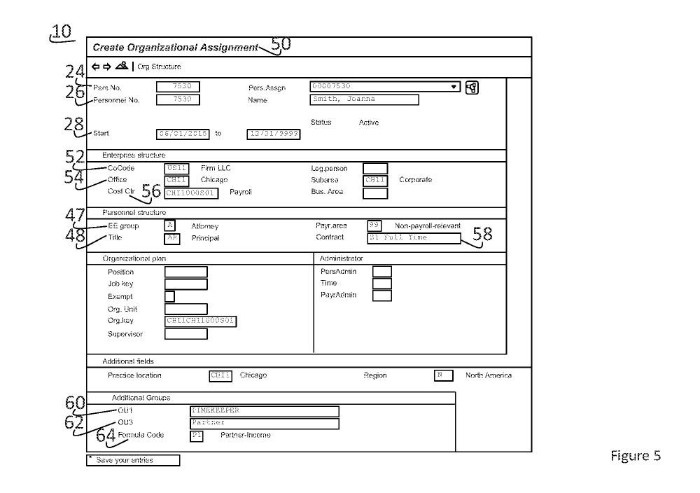

FIG. 5 shows the present inventive System 10 with a section with a Header 50 “Create Organizational-Assignment” a Personal No. 24, a Personnel No. 26, a Start Date 28, a Company Code 52, an Office Code 54, a Cost Center 56 for the employee charges to accrue against, the Employee Group 47, the Employee Title 48 and the Contract type 58 which is full time, the Additional Group OU1 for a Timekeeper 60, and Additional Group OU3 62 which is a Partner, and a Formula Code 64 for the new hire to be an Income Partner.

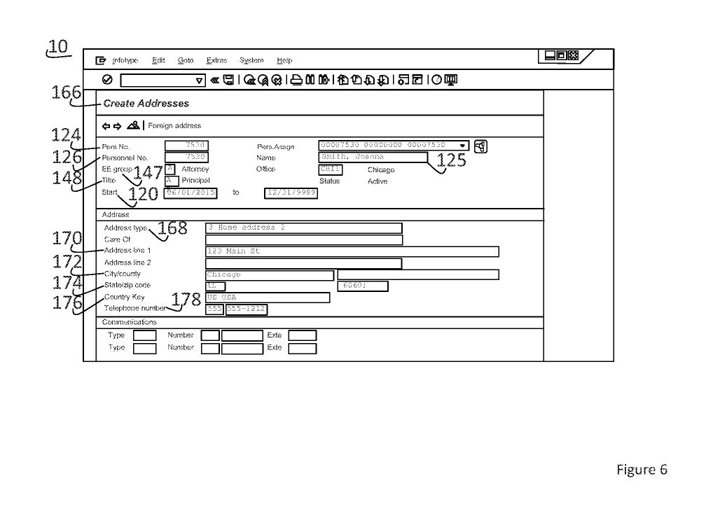

FIG. 6 shows the present inventive System 10 showing a screen shot with a Header “Create Addresses” with Personal No. 124, a Personnel No. 126, Employee Group 147, Title 148, a Start Date 120 and the Employee name 125 for which Address information is entered in the Address Box, with Address type 168, Address line 1 170, City/County field 172, State and Zip code field 174, Country Key 176 and Telephone Number 178. By choosing the Address type field 168, a wide variety of addresses for an Employee may be entered into the System.

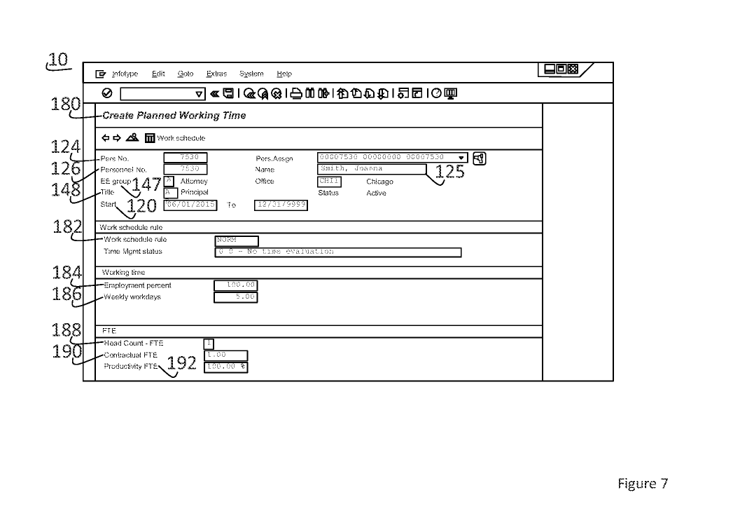

FIG. 7 shows the present inventive System 10 with a Header “Create Planned Working Time” 180 with Personal No. 124, a Personnel No. 126, Employee Group 147, Title 148, a Start Date 120 and the Employee name 125 and Work schedule rule 182 which is “normal” employment percent 184, Weekly workdays 186 and FTE or Full Time Equivalent with Head count FTE 188 being 1, Contractual FTE 190 being “1.0” and Productivity FTE 192 being 100%.

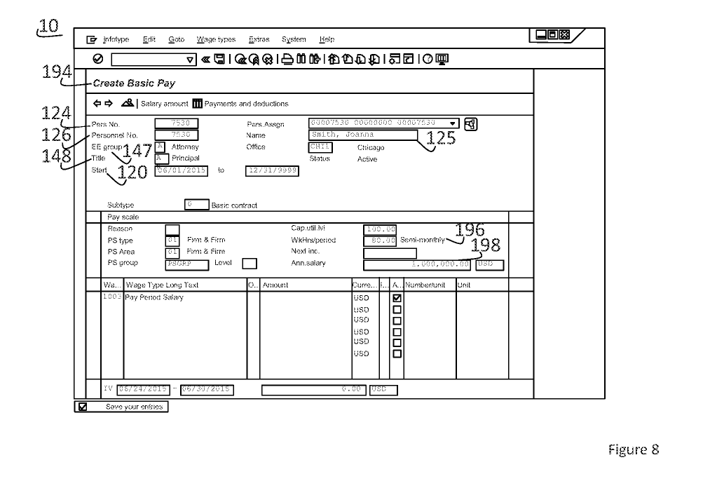

FIG. 8 shows the present inventive System 10 with a Header “Basic Pay” 194, Personal No. 124, a-Personnel No. 126, Employee Group 147, Title 148, a Start Date 120 and the Employee name 125, and the Pay Period Salary, an Annual Salary 198 field of $1,000,000, a Work Hours per period field 196 of semi-monthly and a check box to save the new entry.

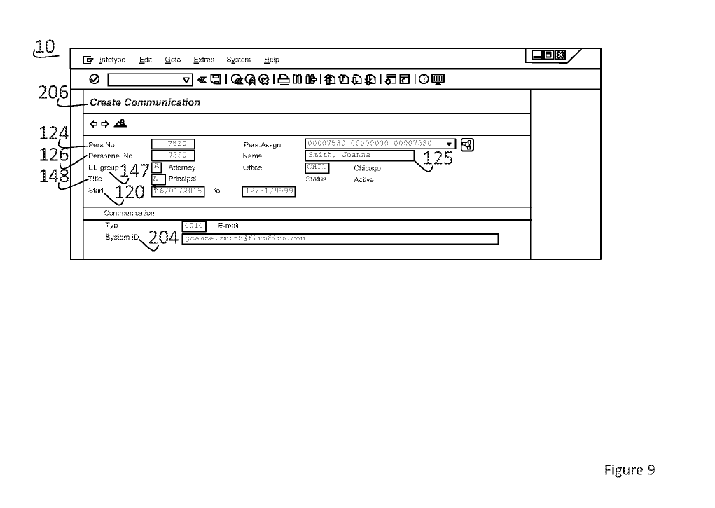

FIG. 9 shows the present inventive System 10 having a Header “Create Communication” 206, Personal No. 124, a Personnel No. 126, Employee Group 147, Title 148, a Start Date 120 and the Employee name 125, and a Communication box with a System ID 204 and the employee's email at the Company or Firm.

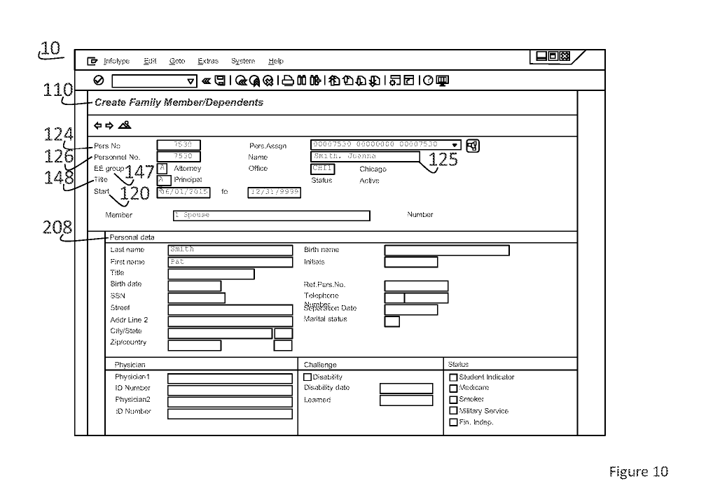

FIG. 10 shows the present inventive System 10 with a Header “Create Communication” 110, Personal No. 124, a Personnel No. 126, Employee Group 147, Title 148, a Start Date 120 and the Employee name 125, and Name and information of the Dependents 208.

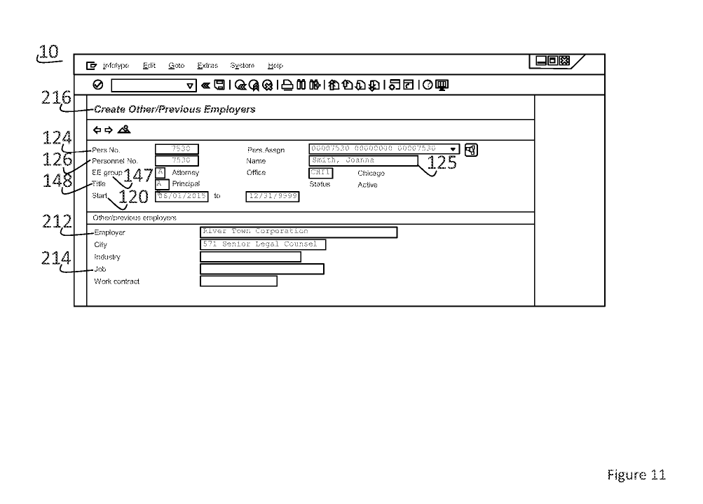

FIG. 11 shows the present inventive System 10 with a Header “Create Other/Previous Employers” 116, Personal No. 124, a Personnel No. 126, Employee Group 147, Title 148, a Start Date 120 and the Employee name 125, a Previous Employer field 212 and a previous job description 214 with the applicant's prior job title.

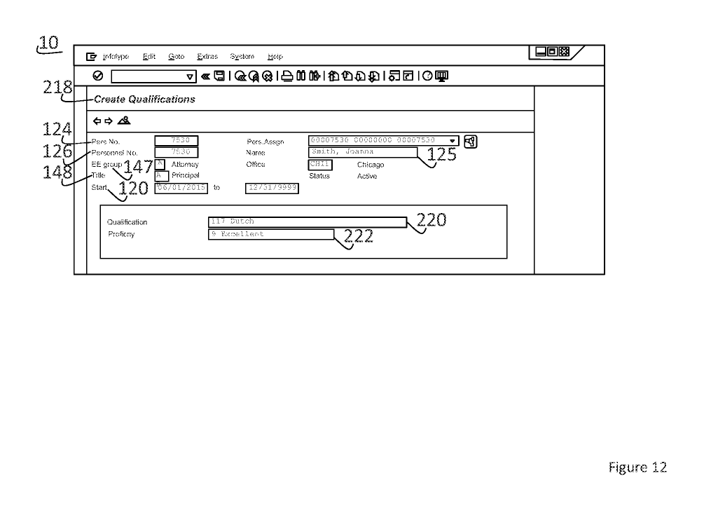

FIG. 12 shows the present inventive System 10 with a Header “Create Qualifications” 218, Personal No. 124, a Personnel No. 126, Employee Group 147, Title 148, a Start Date 120 and the Employee name 125, and a Qualification field 220 showing the job Candidate speaks “Dutch” and a Proficiency Field 222 indicating the skills are “excellent”.

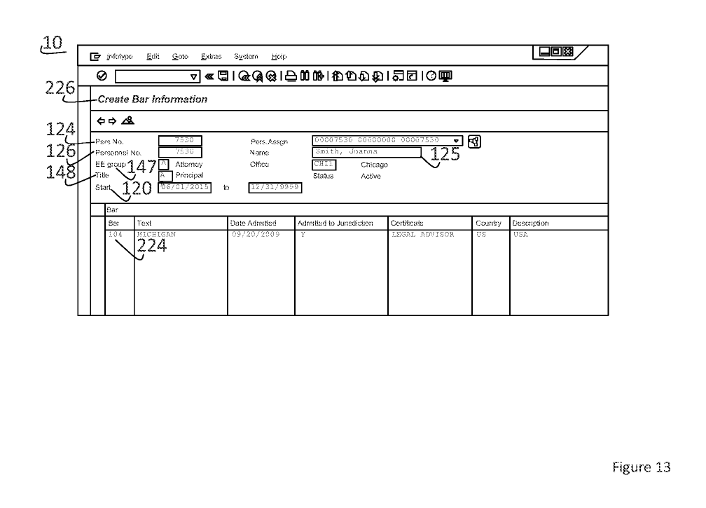

FIG. 13 shows the present inventive System 10 having a Header “Create Bar Information” 226, Personal No. 124, a Personnel No. 126, Employee Group 147, Title 148, a Start Date 120 and the Employee name 125, and a License Admission table 224 indicating the Job Applicant was admitted to the Michigan Bar in 2009.

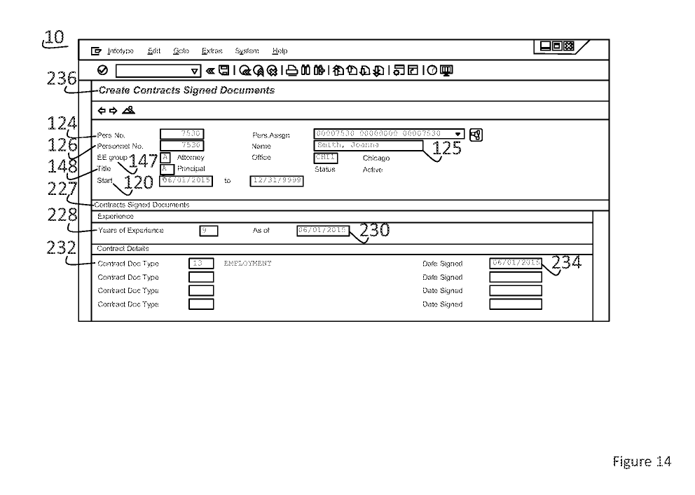

FIG. 14 shows the present inventive System 10 having a Header “Create Contracts Signed Documents” 236, Personal No. 124, a Personnel No. 126, Employee Group 147, Title 148, a Start Date 120 and the Employee name 125, and a Signed Documents table 227 listing one Contract, an Employment Contract Signed field 234 indicating an Employment Agreement was signed on Jun. 1, 2015. Also shown is a Years of Experience field 228 indicating this Job Applicant has 9 years of experience, and an “As of” Field 230 indicating the dating for this Experience field 228 of 9 years.

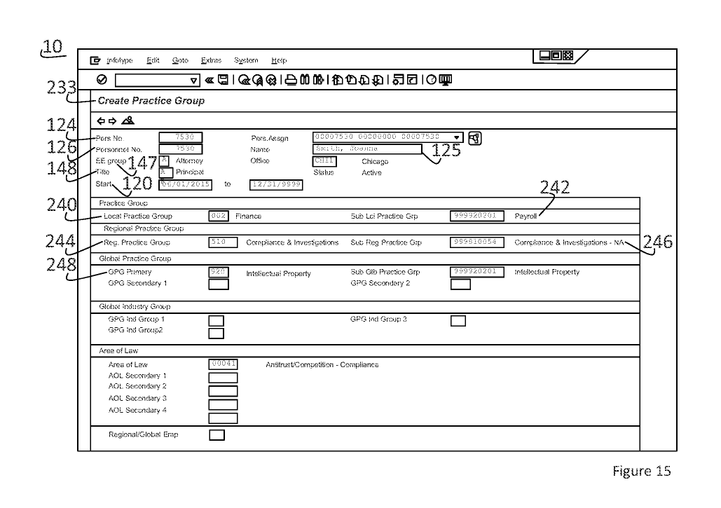

FIG. 15 shows the present inventive System 10 with a Header “Practice Group” 233, a Personal No. 124, a Personnel No. 126, Employee Group 147, Title 148, a Start Date 120 and the Employee name 125, with a Practice Group table indicating a Local Practice Group field 240 for Finance and a Sub Local Practice Group Field 242 indicating Payroll, a Regional Practice Group field 244 for Compliance and Investigations, a Sub Regional Practice Group Field 246 indicating Compliance and Investigations, a Global Practice Group field 248 indicating Intellectual Property.

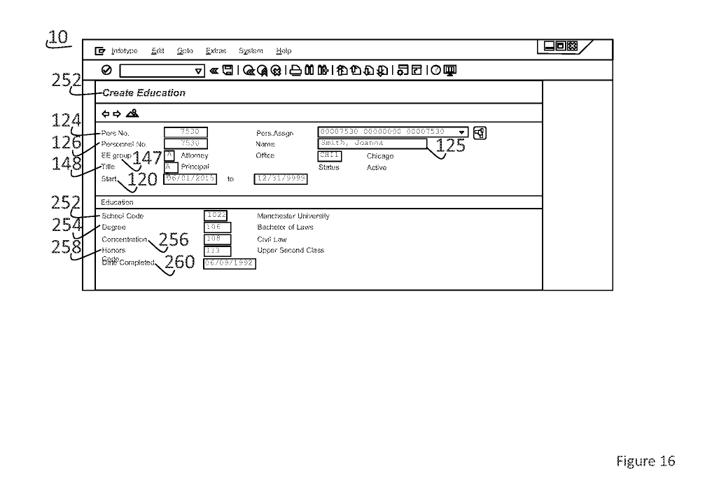

FIG. 16 shows the present inventive System 10 with a Header “Create Education” 250, a Personal No. 124, a Personnel No. 126, Employee Group 147, Title 148, a Start Date 120 and the Employee name 125, with an Education Field showing School Code 252 and the ID of the University, a Degree field 254 showing the name of the degree received, a Concentration Field 256 showing an area of concentration, an Honors Code 258, showing any honors received and a Date Completed field 260.

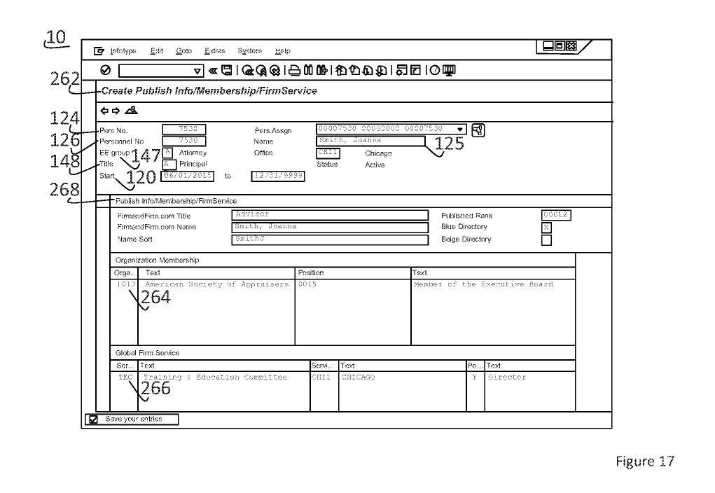

FIG. 17 shows the present inventive System 10 with a Header “Create Publish Info/Membership/Firm Service” 262, a Personal No. 124, a Personnel No. 126, Employee Group 147, Title 148, a Start Date 120 and the Employee name 125, a Publish Info/Member Firm Service sub field 268, the Organizational Membership field 264 and the Global Firm Service Field 266 indicating the Job Applicant has served on the Training and Education Committee.

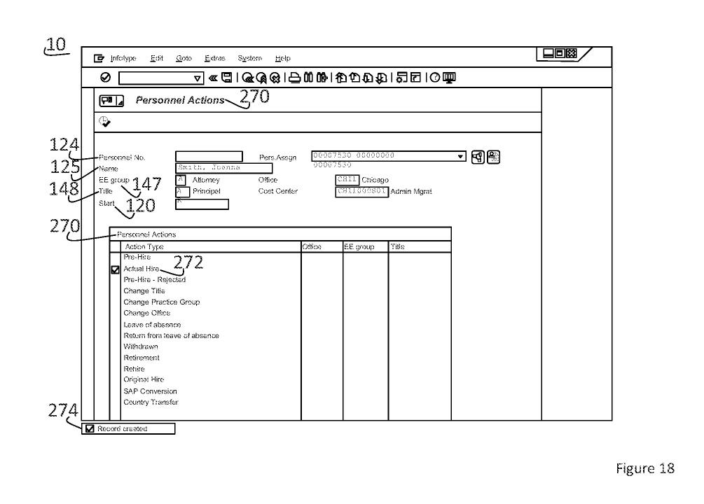

FIG. 18 shows the present inventive System 10 having a Header “Personnel Actions” 270, a Personal No. 124, a Personnel No. 126, Employee Group 147, Title 148, a Start Date 120 and the Employee name 125, a check box 272 for designating the Job Applicant as an “Actual Hire” after the Job Applicant has signed and accepted an Employee Agreement. This new data is saved by checking the “Record Created” box 274.

The foregoing screenshots are just a sampling of the numerous methods to enter and store data relating to all aspects of pre-employment, active employment and post-employment for any company or firm employee or independent contractor of the company or firm.

The following words, as used in this application are interchangeable and the invention disclosed herein is well suited and adapted to be utilized in association with the following business organizations and groups: companies, corporations, unincorporated business associations and ventures, company, business, business organization, business venture, partnership, NFP or Not for Profit, LLC, PC, Swiss Vereins, German Gmbh, and any type of business company, organization or association commonly formed in all relevant business industries.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. A management system comprising:
a user interface configured to receive a plurality of employee data for Timekeeper in a plurality of languages, associated with a Timekeeper ID and personnel number further associated with a plurality of practice groups and practice countries;
a database configured to store employee data; and
a server comprising a processor and non-transitory storage medium for storing instructions that when executed by a processor, perform the following:
said database storing said plurality of employee data for Timekeeper in a plurality of languages, associated with a Timekeeper ID and personnel number further associated with a plurality of practice groups and practice countries.

2. The System according to claim 1, wherein employee data is updated and transmitted to said Timekeeper's clients according to social media information, legal information, and other information relevant to the field of business of said Timekeeper's practice group.

3. The System according to claim 1, wherein employee data further consists of professional licenses, references, resume, interview ratings of said Timekeeper.

4. (canceled)

5. The System according to claim 1, further comprising: security where only authorized personnel may access said employee data by selecting from one or more personnel categories: employee name, job title, employee level, and department, wherein said employee data is protected according to country specific privacy laws and said authorized personnel is limited to personnel classified under the global office.

6. (canceled)

7. The System according to claim 1, further comprising: the ability to track post-employment data and entering additional data into said database, consisting of one or more of the following: termination date, pension, life insurance, life insurance beneficiaries, vested value of life insurance, vested value of said Timekeeper's pension, date of death of said Timekeeper, name of beneficiaries receiving death benefits, and the value of death benefits.

8. The System according to claim 1, further comprising a list of said Timekeeper's clients synced with said database for billing or reporting according to said Timekeeper ID and personnel number.

9. The System according to claim 1, wherein said list of potential hire's clients is compared to said database further consisting of preexisting company clients in which the system automatically flags conflicts found.

10. The System according to claim 3, wherein the dates of renewal for said Timekeeper's licenses are recorded and a reminder is electronically sent to said Timekeeper when said license is due to be renewed in advance of the renewal date recorded.

11. A Method of managing employment data consisting of:
receiving said plurality of employee data for Timekeeper in a plurality of languages, associated with a Timekeeper ID and personnel number further associated with a plurality of practice groups and practice countries;
and storing said plurality of employee data.

12. (canceled)

13. The Method according to claim 11, further having the step of entering and storing employment data further consisting of professional licenses, references, resume, and interview ratings of said Timekeeper.

14. (canceled)

15. The Method according to claim 11, further having the step of: providing security where only authorized personnel may access said employee data by selecting from one or more personnel categories:
employee name, job title, employee level, and company department, wherein said employee data is protected according to country specific privacy laws and said authorized personnel is limited to personnel classified under the global office.

16. (canceled)

17. The Method according to claim 11, further having the step of: tracking post-employment data and entering additional data consisting of one or more of the following: termination date, pension, life insurance, life insurance beneficiaries, vested value of life insurance, vested value of a said Timekeeper's pension, the date of death of said Timekeeper, the name of beneficiaries receiving death benefits, and the value of death benefits received by beneficiaries.

18. The Method according to claim 11, further having the step of: syncing said Timekeeper's client list with said database for billing or reporting according to said Timekeeper ID and personnel number.

19. The Method according to claim 18, further having the step of: comparing the new hire's list of clients for conflict checking to said company's database of clients and automatically flagging any conflicts found.

20. The Method according to claim 13, further having the step of: recording the dates of renewal for said Timekeeper's licenses and sending a reminder electronically to said Timekeeper when any license is due to be renewed in advance of said renewal date stored in said company's database.

21. (canceled)

22. (canceled)

23. The System according to claim 1, wherein said Timekeeper is categorized as an employee or independent contractor in order to associate said Timekeeper with tax structure that corresponds to said category.

24. The System according to claim 1, wherein said Timekeeper's productivity is configured into a report from at least one of the following: company headcount, contractual obligations based on days worked, and productivity.

25. The System according to claim 1, wherein Timekeeper is transferred from one practice country to another practice country and said Timekeeper is associated with a second personnel number that corresponds to new practice country, wherein first and second personnel numbers are associated with one Timekeeper ID in order to track full employment history of said Timekeeper, wherein date of said transfer is recorded in said database and billing system of said database is automatically updated according to said transfer.

26. The System according to claim 1, wherein an automatic notification is sent to the administration of said database in order to update Timekeeper's new tax liability, billing rate, and employment status when at least one of the following changes occur to said Timekeeper:
Change of Title;
Change of Office;
Change of Practice Group;
Leave of Absence;
Return from Leave of Absence;
Retirement;
Withdrawn;
Deceased.

27. The Method according to claim 25, wherein tracking of Timekeeper is done according to a new personnel number associated with Timekeeper's newly assigned country, which is also associated with same Timekeeper ID in order to track full employment history, wherein audit history of changes to said personnel number is stored in said database.

28. The System according to claim 26, wherein the System generates and transmits a monthly report regarding changes including but not limited to termination and change in titles of said Timekeeper.

29. The Method according to claim 11, further having the step of categorizing said Timekeeper as an employee or independent contractor in order to associate said Timekeeper with tax structure that corresponds to said category.

30. The Method according to claim 11, further having the step of configuring Timekeeper's productivity into a report from at least one of the following: company headcount, contractual obligations based on days worked, and productivity.

31. The Method according to claim 11, further having the step of transferring Timekeeper from one practice country to another practice country and associating said Timekeeper with a second personnel number that corresponds to new practice country;
tracking full employment history of said Timekeeper in accordance with first and second personnel numbers associated with one Timekeeper ID;
recording date of said transfer in said database and billing system;
automatically updating said database according to said transfer; and
storing audit history of changes to said personnel number in said database.

32. The Method according to claim 11, further having the step of automatically notifying administration of said database in order to update Timekeeper's new tax liability, billing rate, and employment status when at least one of the following changes occur to said Timekeeper:
Change of Title;
Change of Office;
Change of Practice Group;
Leave of Absence;
Return from Leave of Absence;
Retirement;
Withdrawn;
Deceased.

33. The Method according to claim 11, further having the step of transmitting a monthly report regarding changes including but not limited to termination and change in titles of said Timekeeper.

34. The Method according to claim 11, further having the step of: updating and transmitting employee data to said Timekeeper's clients according social media information, legal information, and other information relevant to the field of business of said Timekeeper's practice group.
